(19) United States
(12) Patent Application Publication
(10) Pub. No.: US 2012/0104102 A1
(43) Pub. Date: May 3, 2012

(54) Sectional Documents Comprising a Structure Equipped with a Watermark or Pseudo-Watermark and Associated Process

(75) Inventors: Sandrine Rancien, La Murette (FR); Thibault Le Loarer, Pommier De Beaurepaire (FR); Pascal Marlin, Coulommiers (FR)

(73) Assignee: ARJOWIGGINS SECURITY, Paris (FR)

(21) Appl. No.: 13/263,680

(22) PCT Filed: Apr. 12, 2010
(86) PCT No.: PCT/IB2010/051555

§ 371 Date: Dec. 19, 2011

(30) Foreign Application Priority Data
Apr. 10, 2009 (FR) 09 52417

(51) Int. Cl. G06K 19/077; G06K 19/02; B32B 38/14; B32B 3/00

(52) U.S. Cl. 235/488; 428/195.1; 156/277

(57) ABSTRACT

The present invention relates to a sectional document (100) comprising: —a support (101) that defines at least two sections (101a, 1010b) connected by at least one fold line (102), —a structure linked to the support (101), especially at the fold line (102), with a possibility of movement relative to the latter and extending at least partially between the two sections (101a, 101b) when the sectional document is folded, the structure comprising: —a fibrous layer (103a, 103b, 104a, 104b), —a substructure (120) comprising a translucent region, —a watermark or pseudo-watermark (10a) borne by the fibrous layer and being superposed at least partially at the translucent region of the substructure, so that the watermark or pseudo-watermark can be observed in light transmitted through the structure, at the translucent region of the substructure, only from the face of the structure situate on the side of the fibrous layer.

The present invention relates to the field of security documents. It relates to a sectional document that has a structure provided with a watermark or pseudo-watermark, and the method for production of such a document.

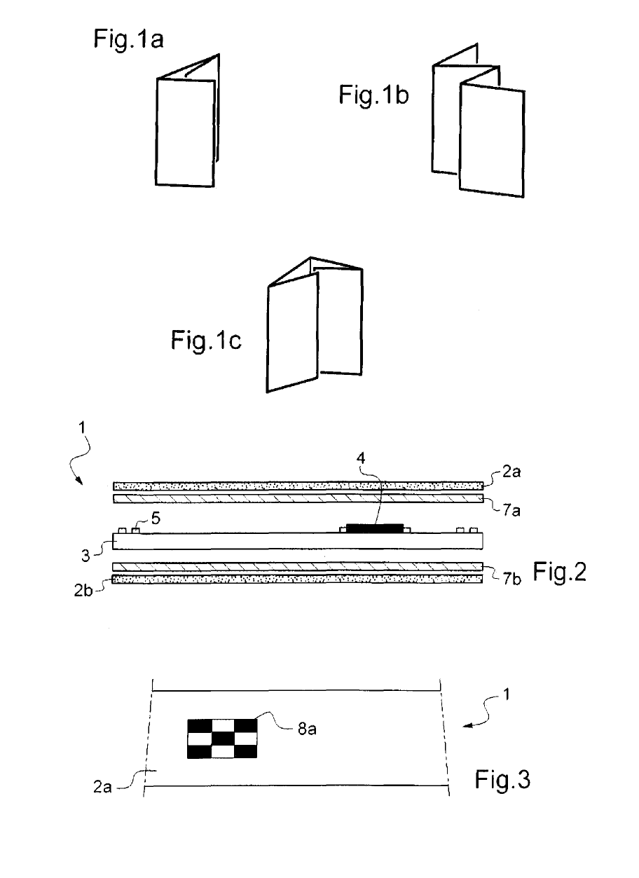

The expression “sectional document” should be understood to mean a document having or not having a function for identifying a person or an object and which includes at least one fold area, such as a passport booklet, a document with three foldable sections in “triptique” form, as represented in FIG. 1a, such as car registration papers or a French driving license or a foldable document in “accordion” form, as represented in FIG. 1b or in “portfolio” form with several sections, as represented in FIG. 1c.

### BACKGROUND

A sectional document, for example a passport booklet, generally has a cover and one or more internal leaves, for example at least sixteen leaves in the case of a passport booklet.

To secure such sectional documents, in particular against forgery and/or counterfeiting attempts, these more often than not include at least one page of an internal leaf which includes security data, for example printed or etched personal data, and, possibly, a photograph relating to the bearer of the sectional document. To further enhance the security, these data can be covered with a holographic protective film. Furthermore, to allow such a document to be authenticated and make counterfeiting attempts more difficult, the sectional document may also include one or more well known security elements, such as a watermark or pseudo-watermark, an integrated microcircuit device, among others, these security elements being able in particular to be printed on one or more pages of the internal leaves and/or integrated therein.

The international application WO 2007/034129 describes a document that includes a cover and an internal leaf that has a page of secured data. The page of data includes in particular a layer showing the visible personal data relating to the bearer of the document and another layer that includes an electronic device in which all or part of these personal data is stored, the two layers being laminated between two other layers of plastic. Such a document presents a number of drawbacks, notably that it is almost impossible to be able to personalize the document after manufacture. In practice, the presence of layers of plastic makes it difficult to physically customize the page of data of the booklet with prints of visible data after the booklet has been assembled. Furthermore, it is also difficult to digitally personalize the document with a storage of all or part of the personal data in the chip simultaneously with the physical personalization of the document by visible prints of these data.

Moreover, it is known practice to use as security means in the security documents watermarks which can be used to authenticate a document by observation in transmitted light.

The watermarks are a safeguard against copying by optical means such as photocopying, photography or scanning.

The watermarks can also be used for decorative and prestige purposes, in particular for printing/writing papers, for example for letterheads or art papers such as papers for water-color painting.

The watermarks are conventionally obtained during production of a sheet of paper in the wet phase by the deposition of pulp on the embossed fabric of a cylinder paper machine, the quantity of deposited pulp being greater in the hollows and lesser in the bosses compared to the rest of the paper.

The watermarks can also be produced by embossing a wet leaf with a watermarking roll (also called “dandy roll”) on a Fourdrinier paper machine.

It is also known practice to produce pseudo-watermarks on a sheet of paper. The pseudo-watermarks reproduce the appearance of a watermark by exhibiting opacity differences. These pseudo-watermarks can be obtained mechanically on the sheet by the application of pressure with or without heat and/or chemically by the application of a composition for example by locally increasing the transparency of the paper using transparentizing substances. The density of fibrous matter between the lighter and darker areas of the pseudo-watermark can be uniform, unlike a conventional watermark.

Furthermore, in order to increase the level of security of the security documents and to make them more difficult to forge, it is also known practice to incorporate integrated microcircuit devices therein, in particular RFID (radio frequency identification devices). These devices, in the form, for example, of a chip associated with an antenna, make it possible to store and, possibly, modify information specific to the bearer or to the object to which they relate, to the type of document issued or to the history of events.

Identity cards that are made of plastic including an RFID device and are produced from an assembly of polymeric layers are known for example. Such cards include little or nothing in the way of authentication security elements, in particular visual, except, sometimes, for surface embossings or holograms applied by transfer. This means that it is relatively easy for a forger to reproduce the visual impressions, personalizations or security information present on such cards using a blank plastic card.

Also known are security cards that include two layers of polyethylene each including a pseudo-watermark produced by hollow or relief embossing, the two pseudo-watermarks being combined when observed in transmitted light.

### SUMMARY

There is a need to further strengthen the security of security documents.

There is in particular a need to propose a novel safeguard against forgery or counterfeiting for sectional documents, which can easily be seen while offering an adequate level of security, more difficult to counterfeit or circumvent.

There is also a need to propose a novel safeguard for sectional documents that allows them to be personalized before, during or after the documents have been produced, in particular with a physical personalization, for example using prints and/or another type of personalization, or digital personalization, for example using an integrated microcircuit device present in the document.

Thus, the subject of the invention, according to one of its aspects, is a sectional document comprising:
a support defining at least two sections linked by at least one fold line,
a structure linked to the support, in particular at the fold line, with a possibility of movement relative to the latter and extending at least partially between the two sections when the sectional document is folded, the structure comprising:
   a fibrous layer,
   a substructure including a translucent region,
   a watermark or pseudo-watermark borne by the fibrous layer and superposed at least partially on the translucent region of the substructure, so that the watermark or pseudo-watermark can be seen in light transmitted through the structure, in the translucent region of the substructure, only from the face of the structure situated to the side of the fibrous layer, that is to say, the face adjacent to the fibrous layer.

For example, in the case of a document such as a passport, the support may consist of the cover of the passport onto which a fibrous leaf forming the flyleaf and the end page is intended to be glued.

The structure may also include, in its thickness, an integrated microcircuit device, in particular with contactless and/or contact-based communication. In particular, the integrated microcircuit device may be borne by the substructure.

By virtue of the invention, it is possible to benefit from a security structure in a sectional document that offers the security associated with the presence of at least one watermark or pseudo-watermark, and possibly linked to the presence of an integrated microcircuit device. Furthermore, the presence of at least one fibrous layer can allow for the physical personalization, notably by printing, of the sectional document, whether this is before, during or after the production of the sectional document, in particular the sealing or the gluing of one or more fibrous layers with the substructure.

Moreover, in a traditional booklet document, there may be internal leaves that include a fibrous layer that is watermarked and such that the watermark can be observed in light transmitted from each side of the fibrous layer. Advantageously, the invention provides a novel means for securing sectional documents, by virtue of the presence of a structure that includes a fibrous layer that is watermarked such that the watermark can be observed in light transmitted in the translucent region only from the face of the structure situated on the side of the watermarked fibrous layer.

The movement of the structure relative to the support may correspond to a rotation about the axis formed by the fold line of the sectional document. The structure can in particular be displaced in a way similar to an internal leaf of the sectional document.

The structure may correspond to an internal leaf of the sectional document.

In particular, the structure may correspond to an internal leaf having at least one page of data showing personal data, for example in the form of prints, and possibly a photograph of the bearer of the sectional document.

Preferably, the structure, in particular the substructure, is not glued, laminated or fused, entirely to the support of the sectional document. In particular, the structure does not correspond, preferably, to an internal leaf of the sectional document like a flyleaf page or an end page of the document, glued to the support (or cover) of the sectional document in order to allow it to be observed in transmitted light.

The substructure can be linked to the support, and in particular to the fibrous layer, only at the fold line, that is to say that the substructure is mobile in the same way as an internal leaf. In this case, the substructure is mobile in rotation about the axis formed by the fold line of the sectional document. In the case of the passport, the substructure is arranged in the booklet of the internal leaves of the sectional document by being mobile relative to the fibrous layer bearing the watermark or pseudo-watermark about the axis of the fold line. Preferably, the substructure and the fibrous layer bearing the watermark or pseudo-watermark are adjacent in the booklet of the internal leaves, at least in the closed position of the passport. In order to authenticate the document, it is then sufficient to hold together the substructure and the fibrous layer in a superposed manner to confirm that the watermark or pseudo-watermark can be observed in light transmitted through the structure, in the translucent region of the substructure, only from the face of the structure situated on the side of the fibrous layer.

The structure, in particular the substructure, can be linked to the support totally or partially, for example by at least a part of an edge thereof, by a hinge, by a spiral binding, by stitching, by gluing, by sealing, by fusion, by folding, by stapling, among other things. The structure, in particular the substructure, can be linked to the support at the fold line and/or an edge of the support, for example a bottom or top edge of the support.

The structure can be folded relative to the support, in particular along a fold area common to the fold area of the support. At least one part of the structure can be extended over a section and overlap onto a second section along a strip parallel to the fold line, in particular at an edge, the strip enabling the support to be linked to the sectional document. The structure and/or the strip may, for example, include perforations to enable the structure to be linked to the support, at the fold line, for example using a spiral binding.

Two internal leaves of the sectional document can be formed from one and the same leaf folded on itself and linked along a fold line to form the two internal leaves.

Two internal leaves of the sectional document can also be formed from at least two different leaves folded and linked together along their fold line to form the two internal leaves.

### Watermark(s) or Pseudo-Watermark(s)

The structure may include a watermark borne by the fibrous layer and at least partially superposed on the translucent region of the substructure, so that the watermark can be observed in light transmitted through the structure in the translucent region only from the face of the structure situated on the side of the fibrous layer, that is to say, from the face of the structure opposite the one in contact with the substructure.

As a variant, the structure may include a pseudo-watermark borne by the fibrous layer and at least partially superposed on the translucent region of the substructure, so that the pseudo-watermark can be observed in light transmitted through the structure in the translucent region only from the face of the structure situated on the side of the fibrous layer, that is to say from the face of the structure opposite the one in contact with the substructure.

The structure may include two fibrous layers, the substructure including a translucent region being situated between the fibrous layers, at least in the position of superposition. In this case, the latter may each include a watermark or pseudo-watermark, which can be observed in light transmitted through the structure, in the translucent region of the substructure, only from the face of the structure situated on the side of the fibrous layer which bears it when the fibrous layers and the substructure are superposed. Thus, the observations of the watermarks or pseudo-watermarks are done in a distinct manner from different respective faces of the structure.

In an exemplary implementation of the invention, the structure has a recto face and a verso face, includes a first fibrous layer bearing at least one first watermark or pseudo-watermark and a second fibrous layer bearing at least one second watermark or pseudo-watermark, the first watermark or pseudo-watermark being observable in transmitted light, at least partially, only from the recto face of the structure and the second watermark or pseudo-watermark being observable in transmitted light, at least partially, only from the verso face of the structure. Furthermore, the watermarks or pseudo-watermarks are preferably at least partially juxtaposed in the translucent region of the substructure. All or part of these watermarks or pseudo-watermarks may thus not be able to be observed simultaneously in light transmitted from one and the same side of the structure in the translucent region of the substructure. The translucent region of the substructure can thus make it possible to prevent the watermarks or pseudo-watermarks from being combined.

Alternatively, the substructure may be linked to two fibrous layers only by the fold line so as to be arranged in the booklet of internal leaves sandwiched between the two fibrous layers each bearing a watermark or pseudo-watermark. In this case, the substructure is arranged in the booklet of the internal leaves of the sectional document by being mobile relative to each of the fibrous layers about the axis of the fold line. In order to authenticate the document, it is then sufficient to hold together in a superposed manner the substructure and the fibrous layers to confirm that the watermark or pseudo-watermark of a fibrous layer can be observed in light transmitted through the structure, in the translucent region of the substructure, only from the face of the structure situated on the side of this fibrous layer.

“Watermark or pseudo-watermark” should be understood, according to the invention, to mean a drawn image which appears in the thickness of the structure.

The watermark or pseudo-watermark can be produced in different ways known to those skilled in the art.

The watermark may be a design etched or pressed into a fibrous layer during its production. Such a watermark may, for example, be seen by transparency by creating thinner or thicker areas of pulp at the time of production of the fibrous layer on a cylinder paper machine using a relief or hollow imprint in the forming fabric of the cylinder. In this way, opacity differences are created and the denser pulp areas appear darker than the less dense areas which appear lighter relative to the rest of the leaf (called vellum part), when the leaf is observed (after drying) in transmitted light. The watermarks that have different gray levels depending on the height of the embossings are called “multitone watermarks”.

The watermark may also come from areas where the fibrous layer has been pressed on a Fourdrinier paper machine using a watermarking roll which includes the etching of the watermarking relief, which has the effect of strongly pressing certain areas of the fibrous layer and of driving out the water contained in the fibers at the time of the formation of the partly wet fibrous layer.

The pseudo-watermark can also be produced in the finished fibrous layer by mechanical and/or chemical means by the application of certain products, this design always being visible in transparency.

The pseudo-watermark can, for example, be produced by depositing or by printing in determined areas of the fibrous layer, a composition which modifies the transparency of the fibrous layer, in particular in order to produce light areas and dark areas, similar to those of a watermark, without, however, obtaining a result that makes it possible to obtain delicate lines and brightness variants comparable to those of a conventional watermark.

It is possible, for example, to transparentize the finished fibrous layer by applying, in determined areas, for example a generally fat composition which transparentizes the fibrous layer permanently, such as, for example, a composition made of oil and transparent mineral material as described in the U.S. Pat. No. 2,021,141 or such as, for example, a composition in the form of a wax combined with a solvent as described in the U.S. Pat. No. 1,479,337.

It is also possible to transparentize the finished fibrous layer by locally applying a wax by hot transfer, as described in the U.S. Pat. No. 5,118,526.

It is also possible to use a fibrous layer including a thermofusible material, for example polyethylene as described in the patent EP 0 203 499, which, under the local action of heat, will vary in transparency.

The finished fibrous layer can be opacified, without, however, making it completely opaque, by applying, in determined areas, an opacifying agent which increases the opacity of the fibrous layer, as is described, for example, in the patent application FR 2 353 676.

The opacifying agent may, for example, be an aqueous suspension of a pigment or of a charge or a solution of a chemical compound, of a colored compound or of a tint. This agent can be applied during the production of the fibrous layer, on the fibrous sheet, and before its removal from the fabric, so that the agent penetrates into the interstices of the sheet and causes the opacity of the sheet to be treated to be modified in selected areas, after drying. This production technique has the drawback of requiring special roller devices for applying the agent, and of preferably employing a suction device to make the agent penetrate into the interstices of the sheet.

It is also possible to produce a pseudo-watermark according to the method described in the document by W. WALENSKI, “Watermarks and Those that Are Not”, Druckspiegel 52, No. 3: 66-68 (March 1997). This document describes a method for producing a pseudo-watermark on a non-layered paper, comprising the application under heat and pressure of a marking piece, representing the pattern of the pseudo-watermark, on a sheet of rewetted paper.

The international application WO 97/17493 also describes the production of layered paper including pseudo-watermarks resulting from a variation of the layer weight applied in determined areas, which induces a variation in thickness and opacity in the areas where the layer weight is reduced or increased.

The international application WO 1999/014433 also describes another method for producing a pseudo-watermark on a layered paper, which provides for the production of an image in the paper after the drying step which follows the final layering operation, by performing the steps in which a rewetting solution is applied to at least one face of the layered paper, in one or more determined areas, and a pressure and a heat are applied in the area or areas of the rewetted layered paper so as to evaporate the solution and densify the layered paper in the area or areas relative to the rest of the paper.

The pseudo-watermark can finally be produced by mechanical means by producing marks by mechanically embossing determined areas of the fibrous layer as described in the patent DE 3 718 452.

When the two fibrous layers of the structure each include a watermark or pseudo-watermark, the two watermarks or pseudo-watermarks may be different. In particular, the watermarks or pseudo-watermarks may be complementary. They may be complementary in their visual effect or in relation to a concept or an image. It is possible, for example, in the case of a structure of a sectional document according to the invention, to apply a national emblem as the first watermark or pseudo-watermark on one side and a text as the second watermark or pseudo-watermark on the other side. In the case of a voucher, the logo of the issuing company and the value of the voucher can be respectively applied.

According to another exemplary embodiment, the two watermarks or pseudo-watermarks are identical but placed symmetrically on each side of the translucent region of the substructure. In the case of an authentication, it may be advantageous to check this visual identity between the watermarks or pseudo-watermarks when they are observed from each of the two faces of the structure (for example a person always looking at the same side, whether by observing the face situated on the side of the first fibrous layer or the face situated on the side of the second fibrous layer).

According to yet another exemplary embodiment, the two watermarks or pseudo-watermarks are at least partially facing one another.

### Integrated Microcircuit Device

The integrated microcircuit device may be adapted to the contactless communication technology, for example such as the one described in the standards ISO 14443, ISO 15693 and ISO 18000.

As a variant, the integrated microcircuit device may be adapted to the contact-based communication technology, for example such as the one described in the standard ISO 7816.

The structure may include an integrated microcircuit device with contact-based communication and an integrated microcircuit device with contactless communication, or even an integrated microcircuit device that allows both a contact-based read and a contactless read. The integrated microcircuit device according to the invention may comprise, in particular, two electronic modules, one for the contact-based technology, the other for the contactless technology, for example for a hybrid chip card or a double-sided contact-based/contactless electronic module for a dual chip card.

The integrated microcircuit device may be capable of communicating with an external reader. The expression “external reader” should be understood to mean any device that makes it possible to communicate with the integrated microcircuit device, to activate it, to authenticate it, to read data contained in it, to receive these data and, if appropriate, to modify them, or even partially or totally delete them. The external reader may operate remotely or require a contact.

The integrated microcircuit device may result from the association of a chip with at least one antenna in the case of a contactless system.

A chip comprises, for example, a semiconductor base, generally a wafer of doped silicon, sometimes made from a semiconductor polymer, and also generally includes a memory, even one or more microprocessors, that make it possible to process data. In order to operate, it can receive energy from a battery or from a cell or be powered by a source of electrical energy provided by contact and/or contactlessly, that is to say, in the latter case, remotely via a communication interface via an antenna. The chip is, for example, linked to the antenna according to a contactless power supply of inductive or capacitive type. The chips with antenna are called “transponders” and generally use radio frequency waves.

In the case where the integrated microcircuit device is said to be “active”, the chip may include a battery, also called “microbattery”, incorporated in its microcircuit or be linked to a microbattery incorporated in the structure. The term “battery” should be understood to mean a source of electrochemically-generated energy, rechargeable or not.

The chip may also be powered by a photovoltaic system.

The antenna of the contactless integrated microcircuit device may be of wired type, printed, in particular by screen printing, etched, glued, transferred, chemically deposited, produced by electroplating, or else borne by the integrated microcircuit device.

The antenna of the contactless integrated microcircuit device may be borne by a fibrous layer, by the substructure or by an adhesive layer, in particular an adhesive layer used to assemble one or more fibrous layers and/or the substructure.

The antenna may be situated on one of the faces of the substructure or be totally incorporated therein. The antenna may be produced on the substructure before assembly with a fibrous layer.

The antenna may be situated between a fibrous layer and the substructure. In particular, the antenna may be borne by a face of a fibrous layer in contact with the substructure. The antenna may be produced on the fibrous layer before assembly with the substructure.

The integrated microcircuit device may be situated on one of the faces of the substructure.

As a variant, the integrated microcircuit device is situated outside the structure, in particular in a fibrous layer of the sectional document, in particular in the cover of said document.

The integrated microcircuit device may be incorporated at least partially in a fibrous layer.

As a variant, the integrated microcircuit device may be incorporated totally in the substructure.

The integrated microcircuit device may be at least partially visible on one of the faces of the structure, in particular when it is contact-based.

The integrated microcircuit device may be housed, at least partially, in the substructure, that is to say that all or part of the integrated microcircuit device is compensated in thickness by the substructure. This makes it possible for example to protect the integrated microcircuit device, which is generally a fragile part, while making access to it by possible fraudsters particularly difficult. The integrated microcircuit device may even be at least partially compensated in thickness by an adhesive layer of the substructure, used to assemble it with one or more fibrous layers. The thickness of the substructure may exceed that of the integrated microcircuit device.

According to an exemplary embodiment, the integrated microcircuit device is flush with at least one face of the substructure. The integrated microcircuit device may be flush with each of the faces of the substructure.

The integrated microcircuit device may be associated, for example connected, with one or more electronic devices chosen from the following list:
an electroluminescent system, notably LED or OLED,
a display device, for example a screen,
a sensor,
a coupling antenna,
a switch.

The integrated microcircuit device may also include one or more of the electronic devices mentioned above. As a variant, the electronic device or devices may be independent of the integrated microcircuit device, preferably being linked to the integrated microcircuit device by a wired, optical or radio frequency link, for example by inductive coupling.

The electronic device or devices may be supplied with electricity by a battery present on the integrated microcircuit device, in particular by an on-chip microbattery.

The electronic device or devices may also be powered by a cell or an external battery, not present on the integrated microcircuit device, for example a battery on distinct thin flexible layers of a chip or by a photovoltaic cell, for example at least partially printed.

The electronic device or devices may also be powered by capacitive or inductive coupling, for example in a communication between the integrated microcircuit device and an external reader.

The electronic device or devices, and possibly the associated power supply device or devices, for example one or more batteries, may be housed in the thickness of one of the layers of the structure, or, as a variant, be produced by printing on one of the layers of the structure.

In an exemplary embodiment, the electronic device or devices are added to the structure as additional security means that may or may not interact with the outside. For example, the electronic device may be a switch which operates an electroluminescent device.

The electronic device or devices may correspond to a detector. The detector may be configured to detect a change of at least one physical-chemical quantity. The detection may be made outside the reading field of an external reader capable of obtaining from the integrated microcircuit device at least one information item relating to said change, and the integrated microcircuit device may be configured to signal to the external reader, in a communication therewith, an attempt to breach the physical integrity of the structure following the detection of a change corresponding to said at least one physical-chemical quantity.

The integrated microcircuit device is advantageously capable of retaining the change or changes in memory.

The expression “physical-chemical quantity” is used to mean a parameter or an intrinsic characteristic property of the structure or of an element present in or on the structure, the value of this parameter or of this property being modified by an intrusion or a physical violation of the structure.

In another exemplary implementation of the invention, the electronic device or devices are incorporated in the structure in order to add a particular functionality, for example associated with the integrated microcircuit device or with another electronic device. For example, an electronic device may be a photovoltaic cell which recharges a battery used by a sensor.

The integrated microcircuit device may also be incorporated in the support of the sectional document.

In this case, the substructure may, for example, correspond to an electromagnetic disturbance element or “magnetic shield”.

An electromagnetic disturbance element may include means for attenuating, disturbing or blocking the electromagnetic coupling between an integrated microcircuit device, in particular contactless, and an external reader, of magnetic material, conductive material or resonator circuit type.

The substructure serving as electromagnetic disturbance element must, however, be able to exhibit sufficient properties to allow for the observation of the watermark(s) or pseudo-watermark(s) only from one of the faces of the structure, in particular sufficient properties in terms of transparency and light diffusion.

Thus, in at least one folded configuration of the sectional document, for example when the angle between the first section and the second section is less than or equal to 10°, the electromagnetic disturbance element prevents read and/or write mode access to the information stored in the integrated microcircuit device, whether the reader is situated in front of the first or second section.

As a variant, the integrated microcircuit device may be incorporated in the support of the sectional document, and the substructure may correspond to an electromagnetic booster.

The electromagnetic booster may make it possible to increase the communication distance between the integrated microcircuit device and an external reader.

### Security Elements

The structure, in particular the substructure and/or the fibrous layer or layers of the structure, may include one or more security elements.

Among the security elements, some can be detected by the naked eye, in daylight or in artificial light, without the use of a particular apparatus. These security elements comprise, for example, colored fibers or flakes, totally or partially metalized or printed wires. These security elements are said to be first level.

Other types of security elements can be detected only using a relatively simple apparatus, such as a lamp emitting in the ultraviolet or the infrared. These security elements include for example fibers, flakes, strips, wires or particles. These security elements may or may not be visible to the naked eye, being for example luminescent under lighting from a Wood lamp emitting in a wavelength of 365 nm. These security elements are said to be second level.

Yet other types of security elements require a more sophisticated detection apparatus in order to be detected. These security elements are, for example, capable of generating a specific signal when they are subjected, simultaneously or not, to one or more external excitation sources. The automatic detection of the signal makes it possible to authenticate, if necessary, the document. These security elements include for example tracers which take the form of active matter, of particles or of fibers, capable of generating a specific signal when these tracers are subjected to an optronic, electrical, magnetic or electromagnetic excitation. These security elements are said to be third level.

The security elements present within the substructure and/or the fibrous layer or layers may have first, second or third level security characteristics.

The structure, in particular the substructure, may in particular include as security elements, among other things:
luminescent colorants and/or pigments and/or interferential pigments and/or liquid crystal pigments, in particular in printed form or mixed with at least one polymer of at least one layer of the substructure,
photochromic or thermochromic colorants and/or pigments, in particular in printed form or mixed with at least one polymer of at least one layer of the substructure,
an ultraviolet (UV) absorber, in particular in coated form or mixed with at least one polymer of the substructure,
a specific light-collecting material, for example of the “waveguide” type, for example a luminescent light-collecting material such as the polymer films based on polycarbonate marketed by the company BAYER under the trade name LISA®,
an interferential multilayer film,
a structure with variable optical effects based on interferential pigments or liquid crystals,
a birefringent or polarizing layer,
a diffraction structure,
an embossed image,
means producing a “moiré effect”, such an effect being able, for example, to reveal a pattern produced by the superposition of two security elements on the substructure, for example by the convergence of lines of two security elements,
a partially reflecting refractive element,
a transparent lenticular grating,
an element including a combined image comprising at least two interleaved images and/or a revealing means, chosen from a revealing frame and/or a lenticular array, associated with the combined image, at least one of the combined image and the revealing means being included in an area of the structure or of the substructure that is at least partially transparent, the revealing means making it possible, when at least partially superposed on the combined image, to successively observe the interleaved images,
a lens, for example a magnifying glass,
a colored filter.

The structure, in particular the substructure and/or the fibrous layer or layers, may also include as security elements, among other things:
a security wire incorporated for example in the mass of one of the fibrous layers or in a window, possibly including an impression printed in positive or in negative, a fluorescence, a metallic, goniochromatic or holographic effect, with or without one or more demetalized parts, an optical effect of lenticular type such as, for example, the MOTION® wire marketed by the company BGI,
a metalized, goniochromatic or holographic foil,
a layer with variable optical effect based on interferential pigments or liquid crystals,
a flat security element that is relatively small such as a flake, visible or not visible, in particular luminescent,
particles or agglomerates of particles of pigments or colorants of HI-LITE type, visible or not visible, in particular luminescent,
security fibers, in particular metallic, magnetic (with soft and/or hard magnetism), or absorbent, or excitable in the ultraviolets, the visible or the infrared, and in particular the near-infrared (NIR),
photochromic or thermochromic components,
an automatically legible security feature having specific and measurable characteristics of luminescence (for example fluorescence, phosphorescence), of light absorption (for example ultraviolet, visible or infrared), of Raman activity, of magnetism, of microwave interaction, of X-ray interaction or of electrical conductivity.

One or more security elements as defined above may be present in the substructure and/or the fibrous layer or layers or in one or more security elements incorporated in the substructure and/or in the fibrous layer or layers, such as, for example, a wire, a fiber or a flake.

The structure may also include one or more so-called “forgery-proof” security elements, such as, for example, elements that react to chemical products, for example capable of provoking a colored reaction in the presence of specific chemical products, for example chemical products used by forgers.

### Fibrous Layer(s)

The structure may include at least one fibrous layer which may bear a watermark or pseudo-watermark and, preferably, the structure includes two fibrous layers each bearing a watermark or pseudo-watermark, as mentioned above.

The fibrous layer may include one or more fibrous webs assembled, in particular by counter-gluing or by assembly in the wet part of the paper machine when producing said fibrous layer.

The two watermarks or pseudo-watermarks may be able to be at least partially superposed in a configuration of observation of the structure with the fibrous layers sandwiching the substructure in the translucent region, of the two fibrous layers may advantageously not be visually combined in the translucent region of the substructure.

The watermark or pseudo-watermark, at least partially superposed in the translucent region of the substructure, of a fibrous layer may include a portion which is visually combined with a portion of the watermark or pseudo-watermark of the other fibrous layer outside the translucent region of the substructure, and another portion which is not visually combined with any portion of the watermark or pseudo-watermark of the other fibrous layer in the translucent region of the substructure.

The watermark or pseudo-watermark of each fibrous layer may be visible at least partially only on the face of the fibrous layer that includes it, in particular in the translucent region of the substructure. The watermark or pseudo-watermark of each fibrous layer may be at least partially visible on the face of the fibrous layer that does not include it, in particular outside the translucent region of the substructure.

The two fibrous layers may also each include one or more watermarks or pseudo-watermarks, at least partially superposed in the translucent region of the substructure, which are visually combined together outside the translucent region of the substructure to form a pattern. The fibrous layers may be glued, laminated or fused to the substructure in particular in the translucent region. Alternatively, the fibrous layers are simply linked to the substructure in a way that is mobile along the axis of rotation of the fold line.

The fibrous layer or layers may be produced on a Fourdrinier or cylinder paper machine, and the watermarks may be incorporated in the fibrous layer or layers in the wet part according to the conventional methods known to those skilled in the art.

The fibrous layer or layers may also be produced on a Fourdrinier or cylinder paper machine, and the pseudo-watermarks may be produced on the finished layers by mechanical or chemical means according to the conventional methods known to those skilled in the art.

At least one fibrous layer may include prints, in particular for personalization, produced, for example by offset, by photogravure, screen printing or flexography, copper-plate printing, by typography, by laser or inkjet. The prints may, for example, correspond to fixed entries and/or variable entries of an identity document. The prints may include a photograph, for example that of the holder of the document.

At least one fibrous layer may for example be based on paper of the LASERGUARD® or JETGUARD® type, marketed by the company ARJOWIGGINS.

At least one fibrous layer may be colored, fluorescent, iridescent or exhibit any other shading or optical effect.

At least one fibrous layer may be based on cellulosic fibers, for example cotton fibers, and/or synthetic fibers and/or non-cellulosic natural organic fibers and/or mineral fibers.

At least one fibrous layer may have a paper weight of between 60 and 230 g/m², preferably between 70 and 90 g/m².

At least one fibrous layer may have a thickness of between 60 and 220 μm, preferably between 70 and 110 μm, for example approximately 100 μm.

In an exemplary implementation of the invention, at least one fibrous layer includes a void, for example an opening in the form of a reserve without fibers, produced, for example, on a paper machine or outside of a paper machine, for example by die cutting, by laser cutting or by water jet. The void is preferably produced in a part of the fibrous layer that does not include or does not overlap the translucent region of the substructure at the level of the integrated microcircuit device. Two fibrous layers may each include such a void, the voids being, for example, facing one another. In this way, the structure may have a transparent window because of the transparency of the substructure. This window may constitute a security element or house one or more security elements, in particular optical, or facilitate their observation. For example, one or more security elements, in particular optical, may be situated in the substructure, and be observable by virtue of the abovementioned window. This window may also be personalized, for example to show a pattern or a printed, etched, embossed or perforated element, relating to the bearer or to the object to which it relates.

A first print can be produced on the recto face of the substructure, a second print can be produced on the verso face of the substructure and, when observing in show-through mode through the abovementioned window, an additional pattern may appear by moiré effect between the first and second prints.

The void or voids present on at least one fibrous layer may each have a surface area of between 0.1 and 10 cm². The void or voids may have any geometrical shape, in particular rectangular or circular.

At least one fibrous layer may include perforations, for example each with a surface area of between 0.2 and 7 mm² for a diameter of between, for example, 0.5 and 3 mm. Such perforations may be advantageous in that they allow, when assembling the structure, an adhesive, belonging, for example, to the substructure, for example a transparent thermoplastic material, to diffuse through one or more fibrous layers and thus more effectively bind all of the structure.

The perforations may form a pattern, such as an alpha numeric pattern and/or a design and/or a symbol, so as to provide an additional security feature for the structure.

According to another particular exemplary embodiment, at least one fibrous layer includes a patch or a strip that is at least partially transparent and at least one area without fibers situated facing the patch or the strip. The strip or the patch may include a transparent plastic material, and, where appropriate, include one or more security elements such as holographic prints or liquid crystals. Two areas without fibers may each be situated on a fibrous layer, facing one another, so as to form a through-window allowing viewing through the strip or patch.

At least one fibrous layer may include at least one so-called “anti-scrapping” security area providing it with protection against mechanical forgery. This area includes a set of regions of reduced thickness, so that any attempt to alter the surface of this fibrous layer causes the latter to be pierced. Such a security area is described in the patent EP 1 252 389.

### Substructure

The substructure may include a translucent region or be translucent over its entire surface area. The substructure may include a translucent and/or light-diffusing region or be translucent and/or light-diffusing over its entire surface area.

The term “translucent” should be understood to mean that the substructure allows enough light to pass to be able to see through the structure. The term “diffusing” should be understood to mean that the substructure diffuses light because of its nature and its thickness. More specifically, depending on the refractive index of the substructure, the latter may exhibit a light-diffusing power.

The translucent region may extend from one edge to the other of the substructure.

The translucent region may form any pattern and may, for example, be of a rectangular, triangular, square, circular, oval, polygonal, star shape, among others.

The translucent region preferably has the same thickness as the substructure. The translucent region may, for example, occupy more than 50%, more preferably 70% or 80%, even more preferably 90%, of the volume corresponding to the substructure.

The substructure may include several translucent regions, for example more than two, three or four translucent regions. These translucent regions may be arranged regularly or not on the substructure, for example with identical spacings between the regions, or randomly. These translucent regions may form a pattern, for example by being arranged close to one another.

When the substructure includes two separate or juxtaposed translucent regions, the latter may be produced differently, for example with different opacities, to create effects in show-through mode.

The substructure may also include mineral or organic fillers, bubbles, or cavitations giving it a diffusive nature.

The substructure may have a thickness of between 10 and 1000 μm, preferably between 50 and 1000 μm, preferably between 120 μm and 600 μm.

The substructure may have one or more voids as described previously for the fibrous layer or layers.

The substructure may be single-layer or made from an assembly of two or more layers, for example two, three or four layers, in particular fibrous and/or polymeric. The layers may be made of identical or different materials, for example such as those cited below for the substructure.

The substructure may include one or more layers assembled using one or more adhesive layers, for example as defined hereinbelow, or else without adhesive, by fusion or by welding.

The substructure may be a transparent plastic film covered with a material having a high diffusing power, for example nanoparticles.

The antenna associated with the integrated microcircuit device may be situated between two constituent layers of the substructure, being, for example, glued to a face of one of the layers.

The thickness and the nature of the layers of the substructure are advantageously chosen so that the substructure, in particular in the translucent region, exhibits the desired non-opacity and diffusion properties, so as to prevent a combination of the watermarks or pseudo-watermarks of the fibrous layers when observing the structure in transmitted light.

The substructure may include a layer of a thermoplastic material, for example polyethylene (PE), polyvinylchloride (PVC), polyethyleneterephthalate (PET), polycarbonate (PC), polyester carbonate (PEC), polyethyleneterephthalate glycol (PETG) or acrylonitrilebutadiene styrene (ABS), for example in the form of a film or an extruded layer.

The substructure may also include or consist of a fibrous layer, in particular a paper, for example a tracing paper.

The substructure may be composite and include at least one polymer layer and one fibrous layer, each layer being, for example, chosen from the materials mentioned previously.

The substructure may be of the PAPERLAM® type marketed by the company ARJOWIGGINS.

The substructure may extend over the entire surface area of the watermark(s) or pseudo-watermark(s).

The substructure may extend over a part of the structure, preferably from one edge to the other of the structure, in an area facing the watermark(s) or pseudo-watermark(s), for example so as to form a strip. The dimensions of the substructure may correspond to those of the cover of a passport for example, that is to say, with two sections. Alternatively, they correspond to the dimensions of a single section.

The substructure may extend only over a part of the surface area of the watermark(s) or pseudo-watermark(s), a part of the watermark(s) or pseudo-watermark(s) thus being visible only from one face of the structure whereas the part not covered by the substructure is visible from either side of the structure in transmitted light.

The substructure may also consist of a fibrous layer which, during the formation thereof, has had a strip inserted into it constituting the translucent region, for example a transparent plastic film.

### Adhesive Layer(s)

The structure may include at least one adhesive layer, for example between a fibrous layer and the substructure.

In particular, the structure may include two adhesive layers on either side of the substructure.

The adhesive layers may be of different types.

At least one adhesive layer may include a polyolefin, for example polyethylene.

At least one adhesive layer may include an ethylene vinyl acetate.

More generally, at least one adhesive layer may include a material as mentioned above for the substructure.

At least one adhesive layer may include a crosslinking agent. This embodiment may, for example, make it possible to strengthen the adhesion between the different layers. In particular, the crosslinking agent of the adhesive layer may be able to be crosslinked under the action of a radiation, in particular an ultraviolet radiation.

Assembly of the Fibrous Layer or Layers with the Substructure

The fibrous layer or layers can be assembled with the substructure in different ways, for example through the use of one or more adhesive layers or without adhesive layer, for example by fusion or welding.

The adhesive layer or layers may be continuous, that is to say distributed uniformly over the entire surface area of the fibrous layer or layers or of the substructure.

The adhesive layer or layers may on the other hand be discontinuous, in particular according to a pattern and in particular they may be applied by photogravure or by screen printing.

The fibrous layer or layers may therefore be linked, in particular by gluing, partially or totally to the substructure. In particular, the adhesive layer or layers may be applied partially or totally to the fibrous layer or layers, or to the substructure.

The substructure may have, on at least one of its faces, a polymer layer, for example a polycarbonate, enabling it to be directly sealed, hot and under pressure, onto the fibrous layer or layers.

The substructure may also have, on at least one of its faces, a polymer layer coated with an adhesive, for example a layer of polyethyleneterephthalate coated with an ethylene vinyl acetate layer, enabling it to be sealed directly, hot or cold, with or without pressure, onto the fibrous layer or layers.

The fibrous layer or layers may have, on their faces facing the substructure, a surface covering enabling them to be sealed directly, hot and under pressure, onto the substructure. For example, the fibrous layer or layers may include a substrate made of paper impregnated with thermosealing latex.

The fibrous layer or layers may have, on their faces facing the substructure, an adhesive layer enabling them to be sealed directly, cold or hot, with or without pressure, onto the substructure. The adhesive layer or layers on the fibrous layer or layers may correspond to liquid adhesives previously coated, cold or hot, onto the face or faces of the fibrous layer or layers facing the substructure.

In another exemplary embodiment, one or more adhesive layers, preferably non-opaque and optically diffusing, are used to assemble the fibrous layer or layers with the substructure. The adhesive layer or layers may, for example, correspond to one or more pressure-sensitive or thermoplastic films.

The substructure may also include one or more openings or perforations, preferably not superposed on the electronic device and/or on any antenna, in order to enable the adhesive layer or layers used to assemble the fibrous layer or layers with the substructure to mix and thus ensure a better fixing of the substructure with the fibrous layer or layers.

At least one adhesive layer may include one or more security elements as described previously.

The assembly of the substructure with the fibrous layer or layers may take place before, during or after the fixing of the structure to the support of the sectional document.

At least one fibrous layer and/or the substructure may be personalized, in particular using prints and/or data stored in an integrated microcircuit device, before, during or after the fixing of the structure to the sectional document.

Any personalizations of the fibrous layer or layers may be protected, in particular by a transparent film, secured or not.

Said film may be a thick film based on PET or PE, in particular to allow for a hot lamination onto the fibrous layer, or an adhesive film. Such films are notably marketed by the companies Fasver and Hologramm Industries.

The substructure may also be inserted between the two fibrous layers on a paper machine when forming the fibrous layers.

### Structure

The structure according to the invention may have a final thickness of between 100 and 1000 μm, preferably between 150 and 500 μm.

The structure may have a constant thickness. As a variant, the structure may have a variable thickness, in particular higher in the central part than on the edges of the structure.

The sectional document may be an identity document, in particular an identity card or, preferably a passport, a payment means, in particular a requisition or a voucher, a ticket to access cultural or sporting events, a certificate of authenticity.

### Method for Fabricating the Sectional Document

Also the subject of the invention, according to another of its aspects, is a method for fabricating a sectional document as described previously, comprising the steps consisting in:
forming at least one watermark or pseudo-watermark on a fibrous layer of an internal leaf of the sectional document,
at least partially superposing a substructure including a translucent region on said at least one watermark or pseudo-watermark borne by said fibrous layer in said translucent region,
possibly, assembling together, in particular permanently, the substructure and the fibrous layer.

The internal leaf may be folded and linked to the support of the sectional document, for example a passport cover, at the fold line.

The internal leaf may define two internal pages on either side of the fold line of the sectional document, each internal page defining a fibrous layer bearing at least one watermark or pseudo-watermark, so that, by folding the internal leaf at the fold line, the watermarks or pseudo-watermarks are at least partially superposed.

The sectional document may also include at least two distinct internal leaves, each internal leaf defining a fibrous layer bearing at least one watermark or pseudo-watermark, the two watermarks or pseudo-watermarks being situated on one and the same side of the fold line so that they are at least partially superposed.

The sectional document may also include a first internal leaf and a second internal leaf, each internal leaf defining two internal pages on either side of the fold line and each internal page defining a fibrous layer including at least one watermark or pseudo-watermark, so that the watermarks or pseudo-watermarks of the first and second internal layers situated on one and the same side of the fold line are at least partially superposed.

The translucent region of the substructure may be superposed on the fibrous layer in a configuration such that it totally or partially covers the watermark or pseudo-watermark.

When the sectional document includes at least two internal leaves each including a watermark or pseudo-watermark, the translucent region of the substructure may be superposed on the two watermarks or pseudo-watermarks, by being placed between the internal leaves.

The substructure may have variable dimensions. In particular, the substructure may have a width equal to the width of a page of the internal leaf, that is to say, a width equal to the distance between the fold line and the edge of the sectional document.

The substructure may also have a width less than the width of a page of the internal leaf.

As another variant, the substructure may have a width greater than the width of a page of the internal leaf.

When the width of the substructure is less than the width of a page of the internal leaf, this may make it possible to leave an area for assembling the fibrous layers together free in the case of two internal leaves.

The substructure may also have a width less than, equal to or greater than the width of a page of the internal leaf, the substructure being linked, in particular by gluing, sealing or stitching, to the support of the sectional document at the fold line.

The sectional document may include one or more fibrous and/or thermoplastic internal leaves.

The sectional document may, for example, include at least two thermoplastic leaves, associated or not with a thermosealing adhesive layer, between which the structure according to the invention is placed. The structure may or may not include one or more adhesive layers to facilitate its assembly with the thermoplastic internal leaves.

The invention can be better understood by reading, below, the detailed description of nonlimiting exemplary embodiments thereof, and studying the figures of the appended drawing, schematic and partial, in which:

FIGS. 1a to 1c represent different examples of document folds, the structure not being represented in these figures,

FIG. 2 represents, in cross section, an exemplary structure according to the invention,

FIG. 3 represents, by front view, the recto face of the structure of FIG. 2,

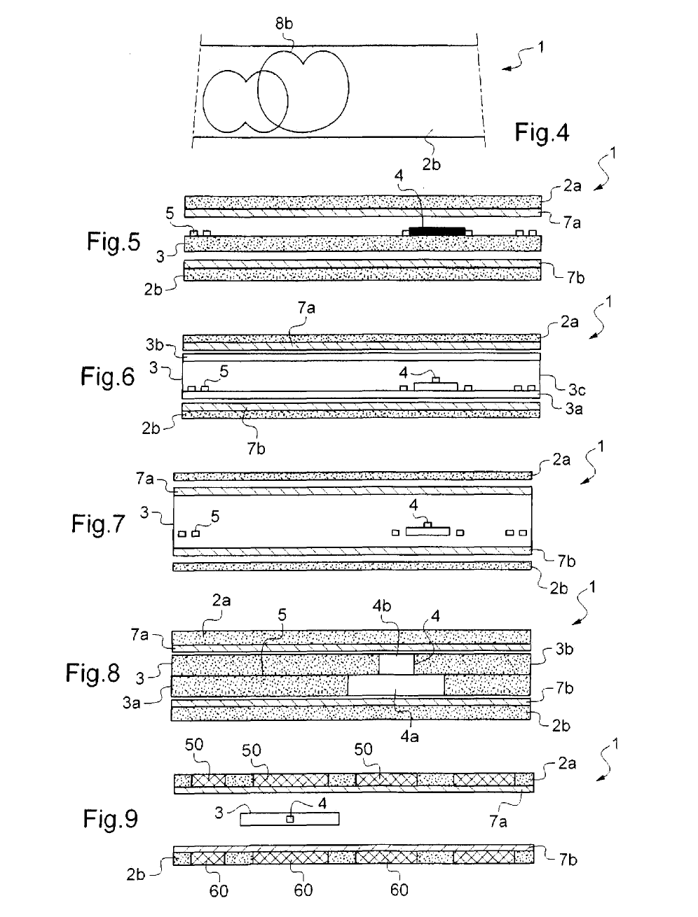

FIG. 4 represents, by front view, the verso face of the structure of FIG. 2,

FIGS. 5 to 8 represent other exemplary structures according to the invention,

FIG. 9 represents, in cross section, another exemplary structure according to the invention,

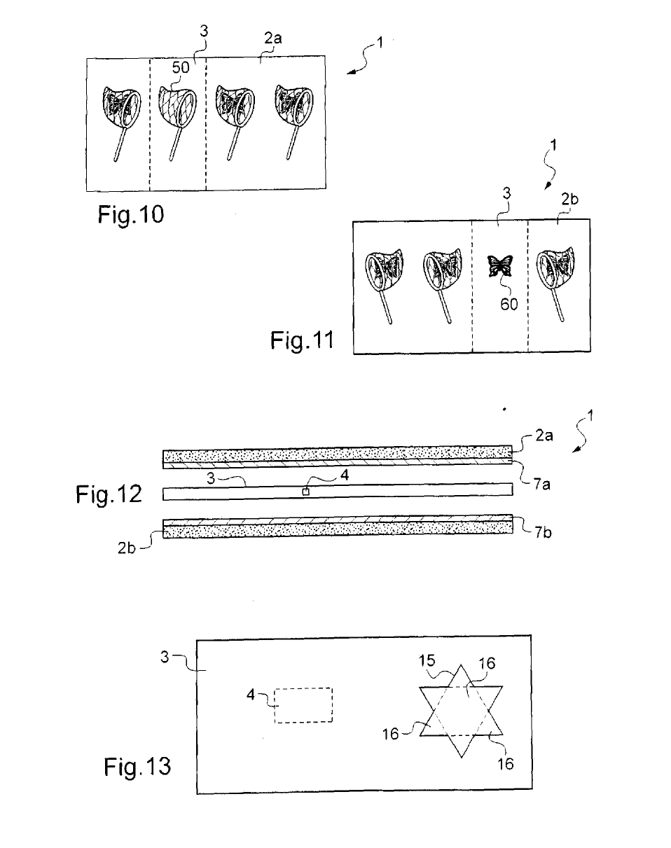

FIGS. 10 and 11 respectively represent, by front view, the recto and verso faces of the structure of FIG. 9,

FIG. 12 represents, in cross section, another exemplary structure according to the invention,

FIG. 13 represents, by front view, the substructure of the structure of FIG. 12,

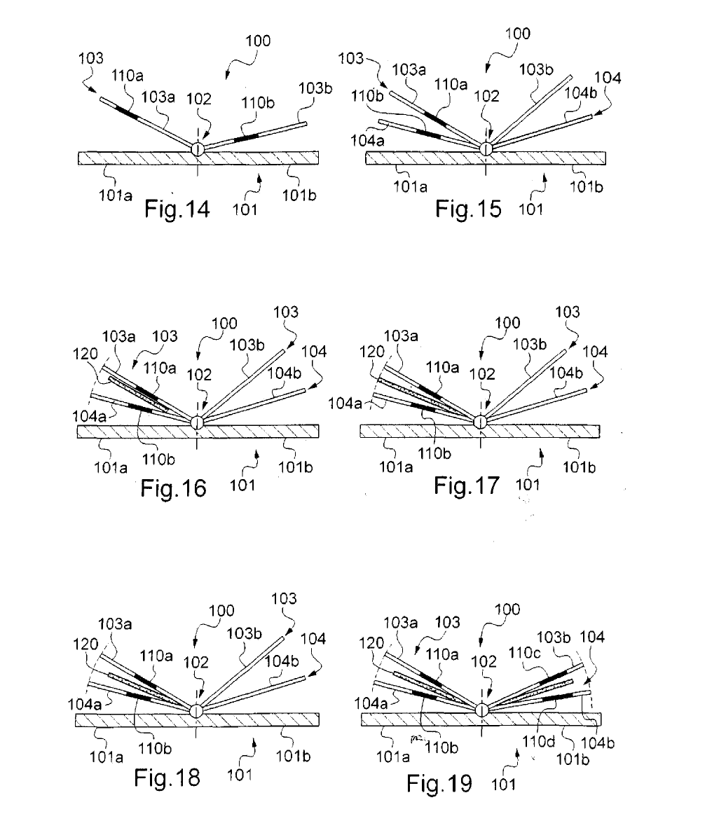

FIGS. 14 to 19 represent, in cross section, examples of sectional documents according to the invention,

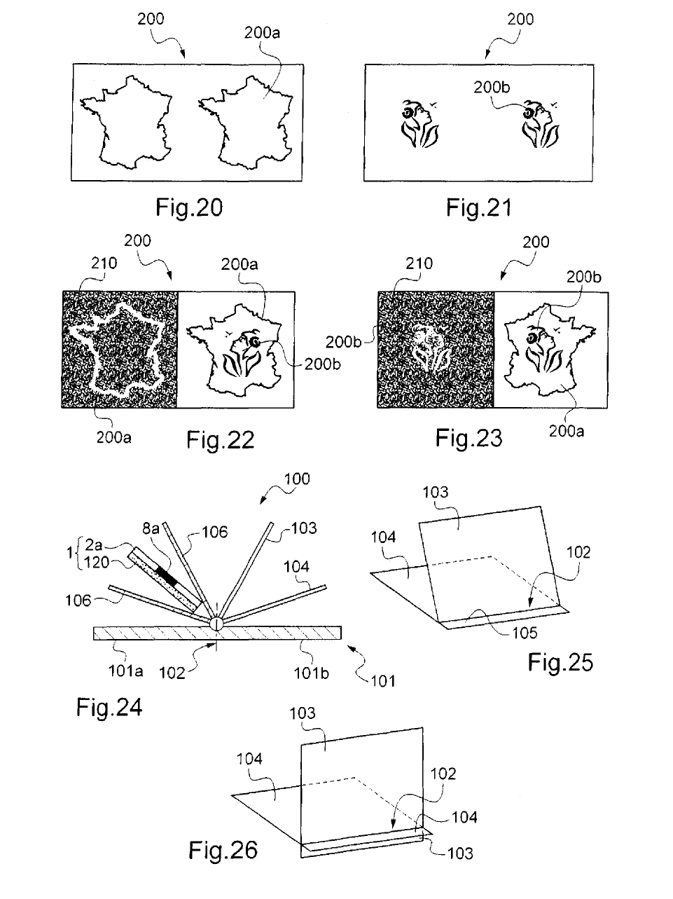

FIGS. 20 to 23 represent, by front view, other examples of observation in transmitted light of structures of sectional documents according to the invention,

FIG. 24 represents, in cross section, another exemplary sectional document according to the invention,

FIGS. 25 and 26 represent, schematically and partially, examples of binding to form two internal leaves of a sectional document according to FIG. 24 of the invention,

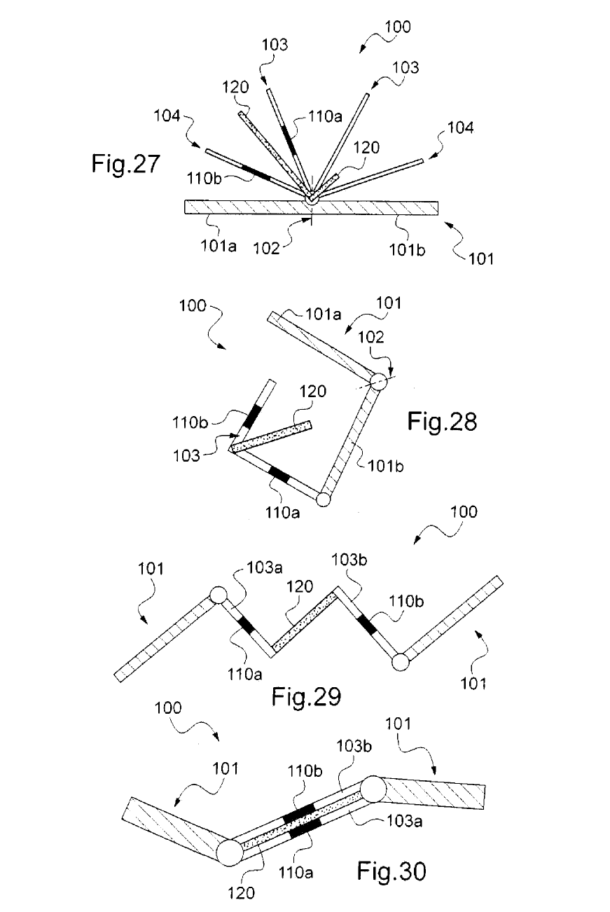

FIGS. 27 and 28 represent, in cross section, other examples of sectional documents according to the invention, and

FIGS. 29 and 30 represent, in cross section, respectively before and after assembly of the structure, another exemplary sectional document according to the invention.

In the design, the proportions between the different elements represented are not always observed in the interests of clarity.

FIG. 2 shows an exemplary structure 1 that can be assembled with the support of a sectional document according to the invention.

The structure 1 includes two fibrous layers 2a and 2b between which is situated a substructure 3 formed by a separating layer made of polymer on which are placed a contactless integrated microcircuit device 4 and an antenna 5. The substructure 3 is, in this example, entirely translucent.

The structure 1 also includes an adhesive layer 7a placed between the substructure 3 and the fibrous layer 2a, and another adhesive layer 7b placed between the substructure 3 and the fibrous layer 2b.

The structure 1 has a greater thickness in the central part, due to the thickness of the assembly formed by the different superposed layers, than at the edges of the structure 1.

The adhesive layers 7a and 7b are, in this example, in the form of films made of thermoplastic polyethylene, which can be hot laminated. The polyethylene layer 7a allows for the partial or total compensation of the integrated microcircuit device 4, the thermoplastic polyethylene layer creeping on either side of the integrated microcircuit device 4 during the lamination process.

The substructure 3 is, in this example, single-layer and takes the form of a transparent polyethyleneterephthalate film at least 100 μm thick.

The substructure 3 bears, on one of its faces, the integrated microcircuit device 4 which may take the form of a chip marketed by the company PHILIPS under the reference MIFARE®.

The integrated microcircuit device 4 is connected to an antenna 5, for example an antenna made of copper etched on one of the faces of the substructure 3.

The two fibrous layers 2a and 2b have, for example, a paper weight equal to 90 g/m².

The fibrous layer 2a includes a watermark or a pseudo-watermark 8a, for example in the form of a checkerboard as illustrated, and the fibrous layer 2b includes a watermark or pseudo-watermark 8b, for example in the form of the association of a cardioid and a nephroid.

Each of the watermarks or pseudo-watermarks 8a and 8b is visible only from one side of the structure 1. In particular, the watermark or pseudo-watermark 8a is visible only from the recto side of the structure 1 with the fibrous layer 2a, and the watermark or pseudo-watermark 8b is visible only from the verso side of the structure 1 with the fibrous layer 2b.

FIG. 3 represents, by front view, the recto face of the structure 1 of FIG. 1.

In this figure, it can be seen that, when the structure 1 is lit from its verso side, only the watermark or pseudo-watermark 8a on the recto side of the structure 1 is observed.

FIG. 4 represents, by front view, the verso face of the structure 1 of FIG. 1.

In this figure, it can be seen that, when the recto face of the structure 1 is lit, only the watermark or pseudo-watermark 8b of the verso side of the structure 1 can be seen.

FIG. 5 shows another exemplary structure 1 according to the invention.

In this example, the structure 1 includes two fibrous layers 2a and 2b for example identical to those of the example of FIG. 1.

The structure 1 also includes a substructure 3 including a translucent fibrous separating layer, one of the faces of which includes a contactless integrated microcircuit device 4 and an antenna 5. The substructure 3 is advantageously entirely translucent.

The substructure 3 is, for example, tracing paper and has, for example, a paper weight equal to 65 g/m².

The integrated circuit device 4 is, for example, of the “flip chip” type connected to an antenna 5, for example based on silver and screen printed.

Each of the fibrous layers 2a and 2b also respectively includes an adhesive layer 7a and 7b, for example in the form of a pressure-sensitive adhesive, previously coated to 25 g/m² for example, on the internal faces of the fibrous layers 2a and 2b.

FIG. 6 shows another exemplary structure 1 according to the invention.

The structure 1 includes two fibrous layers 2a and 2b for example identical to that of the example of FIG. 1. The two fibrous layers 2a and 2b are coated on their internal face with two adhesive layers 7a and 7b enabling them to be subsequently sealed onto the substructure 3.

The structure 1 also includes a substructure 3 consisting of three separating layers 3a, 3b and 3c. The substructure 3 is, in this example, entirely translucent.

The layer 3a is, for example, a transparent polyethyleneterephthalate film, on one of the faces of which are arranged the integrated microcircuit device 4 and the antenna 5.

The integrated microcircuit device 4 is, for example, a chip marketed by the company PHILIPS under the reference MIFARE®, connected to the antenna 5 which is, for example, an etched copper antenna.

The layer 3b is, for example, a transparent polyethyleneterephthalate film on which is coated the layer 3c, which is, for example, a transparent layer of polyethylene and thermoplastic ethylene vinyl acetate. The layer 3c has a thickness greater than or equal to that of the integrated microcircuit device 4, so as to compensate for the thickness of this device.

FIG. 7 shows another exemplary structure 1 according to the invention.

The structure 1 includes two fibrous layers 2a and 2b, having, for example, a paper weight of 65 g/m² and a thickness equal to 70 μm.

The structure 1 also includes a substructure 3 that may consist of several transparent layers of polyethyleneterephthalate and ethylene vinyl acetate (not represented), some of which have at least one void that makes it possible to incorporate an integrated microcircuit device 4 in the form of a module chip connected to an antenna 5. The substructure 3 is advantageously entirely translucent.

Two adhesive layers 7a and 7b are also present on either side of the substructure 3 so as to ensure a cohesion with the fibrous layers 2a and 2b. The adhesive layers 7a and 7b are, for example, thermosealing layers made of ethylene vinyl acetate allowing for the direct lamination of the substructure 3 between the two fibrous layers 2a and 2b.

FIG. 8 shows another exemplary structure 1 according to the invention.

The structure 1 includes two fibrous layers 2a and 2b, for example identical to the fibrous layers 2a and 2b of the example of FIG. 7.

The fibrous layers 2a and 2b of the structure 1 are respectively pre-coated on their internal face with adhesive layers 7a and 7b, which can be activated hot and are thermosetting, applied in the form of liquid adhesives based on polyurethane mixed with a blocked isocyanate.

The structure 1 also includes a substructure 3 which has, for example, a thickness of 260 μm. The substructure is, for example, here entirely translucent.

The substructure 3 includes a layer 3a of paper, for example with a thickness equal to 130 μm, including, on one of its faces, a wired antenna 5 made of copper, fixed for example by ultrasounds, and a void which partially houses a contactless integrated microcircuit device 4.

The substructure 3 also includes a layer 3b made of paper, which has, for example, a thickness equal to 130 μm, also including a void facing the void of the layer 3a, at least partially housing the integrated microcircuit device 4.

The integrated microcircuit device 4 is, for example, a module chip of the MOB 6 type, marketed by the company PHILIPS.

In all the examples of FIGS. 5 to 8, the fibrous layers 2a and 2b of the structure 1 include one or more watermarks or pseudo-watermarks, for example those described in the example of FIG. 2.

FIG. 9 represents another exemplary structure 1 according to the invention.

In this example, the structure 1 includes two fibrous layers 2a and 2b respectively coated on their internal face with two adhesive layers 7a and 7b.

The fibrous layer 2a includes a number of identical watermarks 50, as can be seen in FIG. 10, representing the recto face of the structure 1 of FIG. 9.

The fibrous layer 2b also includes a number of identical watermarks 60, as can be seen in FIG. 11, representing the verso face of the structure 1 of FIG. 9.

A substructure 3 in the form of an entirely translucent and light-diffusing strip, single-layer or not, is placed between the fibrous layers 2a and 2b coated with the adhesive layers 7a and 7b. The substructure 3 advantageously has dimensions, notably a width, less than those of the fibrous layers 2a and 2b. The substructure 3 extends from one edge to the other of the structure 1, in the widthwise direction, as can be seen in FIGS. 10 and 11.

An integrated microcircuit device 4, in the form of a chip of the AOB (Antenna On Board) type with an onboard antenna is incorporated in the substructure 3.

Advantageously, at least a part, or better, all, of a watermark 50 of the fibrous layer 2a and at least a part, or better, all, of a watermark 60 of the fibrous layer 2b are superposed on the substructure 3.

When observing the recto face of the structure 1 at the level of the substructure 3, as represented in FIG. 10, only the watermark 50 of the fibrous layer 2a is visible, and not the watermark 60 of the fibrous layer 2b.

When observing the verso face of the structure 1 at the level of the substructure 3, as represented in FIG. 11, only the watermark 60 of the fibrous layer 2b is visible, and not the watermark 50 of the fibrous layer 2a.

Advantageously, the watermarks 50 and 60 of the fibrous layers 2a and 2b, not superposed on the substructure 3, are visible both from the recto side and from the verso side of the structure 1, as can be seen in FIGS. 10 and 11. Furthermore, these watermarks 50 and 60 can be combined together so as to form a pattern resulting from their combination, representing, in this example, a butterfly enclosed in the net.

Thus, in this example, the combination between the watermarks of the fibrous layers 2a and 2b may, for example, be possible only outside the substructure 3.

FIG. 12 shows another exemplary structure 1 according to the invention.

The structure 1 includes two fibrous layers 2a and 2b and two adhesive layers 7a and 7b identical to those of the structure 1 of FIG. 9.

However, in this example, the structure 1 includes a substructure 3 extending from one edge to the other of the structure 1, in both lengthwise and widthwise directions.

The substructure 3 includes a translucent region 15, obtained, for example, by the juxtaposition of several translucent regions 16 forming between them a pattern, for example in the form of a star.

The fibrous layers 2a and 2b may include one or more watermarks or pseudo-watermarks, for example such as those described previously, preferably at least partially superposed on the translucent region of the substructure 3.

As has been described for the structure of FIG. 9, also illustrated by FIGS. 10 and 11, each part of a watermark or pseudo-watermark situated in the translucent region 15 is visible only from the side of the structure 1 that includes the fibrous layer that supports it. Outside of the translucent region 15, the watermark(s) or pseudo-watermark(s) of the fibrous layer 2a may, for example, be combined with the watermark(s) or pseudo-watermark(s) of the fibrous layer 2b.

FIG. 13 shows, by front view, the substructure 3 of FIG. 12, on which can be seen the pattern formed by the translucent region 15.

In all the exemplary embodiments described previously, the integrated microcircuit device or devices 4 may include or be associated with one or more electronic devices in the form of detectors configured to detect a change of at least one physical-chemical quantity, in particular a physical-chemical quantity characteristic of a layer including the integrated microcircuit device concerned, for example the substructure 3. In this way, it may be possible to signal any attempt to breach the physical integrity of the structure following the detection of a change in the physical-chemical quantity.

FIGS. 14 to 19 show, in cross-section and schematically and partially, exemplary sectional documents 100 according to the invention.

FIG. 14 shows a sectional document 100 including a support 101 defining two sections 101a and 101b linked by a fold line 102.

The sectional document 100 includes, in this example, an internal leaf 103 which has two internal pages 103a and 103b on either side of the fold line 102.

The internal page 103a bears a first watermark or pseudo-watermark 110a, and the internal page 103b bears a second watermark or pseudo-watermark 110b. Thus, the two watermarks or pseudo-watermarks 110a and 110b are borne by one and the same internal leaf 103.

The method for fabricating the sectional document 100 according to the invention notably includes the step consisting in at least partially superposing a substructure (not represented in FIG. 14) on the watermarks or pseudo-watermarks 110a and 110b by placing the substructure between the internal pages 103a and 103b of the internal leaf 103.

FIG. 15 shows another exemplary sectional document 100 according to the invention.

In this example, the sectional document 100 includes two internal leaves 103 and 104 linked together at the fold line 102.

Each internal leaf 103 and 104 includes an internal page 103a and 104a, each bearing a watermark or pseudo-watermark 110a and 110b, the two internal pages 103a and 104a being on a same side of the fold line 102. This way, the watermarks or pseudo-watermarks 110a and 110b are at least partially superposed. Thus, the watermarks or pseudo-watermarks 110a and 110b are borne by two distinct internal leaves 103 and 104 of the sectional document 100.

The method for fabricating the sectional document 100 according to the invention then includes the step consisting in superposing a substructure (not represented in FIG. 15) on the watermarks or pseudo-watermarks 110a and 110b, by placing the substructure between the internal pages 103a and 104a of the internal leaves 103 and 104.

FIGS. 16 to 17 show different examples of the positioning of a substructure 120 between the watermarks or pseudo-watermarks 110a and 110b. These positioning examples are illustrated with a configuration of the sectional document 100 similar to that represented in FIG. 15, but are also applicable to the configuration represented in FIG. 14.

In FIG. 16, the substructure 120 has a width less than the width of the internal pages 103a and 104a so that the sectional document 100 has areas on either side of the substructure 120 which can possibly enable the fibrous layers consisting of the internal pages 103a and 104a to be assembled together. In this example, the substructure 120 may be linked to the fibrous layers consisting of the internal pages 103a and 104a, or, as a variant, be free, that is to say not linked to the support 101 and to the fibrous layers consisting of the internal pages 103a and 104a.

In FIG. 17, the substructure 120 has a width greater than the widths of the internal pages 103a and 104a, and is positioned between the internal pages 103a and 104a so that the external end of the substructure 120 is exactly superposed on the external ends of the internal pages 103a and 104a, and the internal end of the substructure 120, that is to say the end situated at the fold line 102, is fixed to the support 101 at the fold line 102, for example by gluing or stitching.

In FIG. 18, the substructure is also fixed by its internal end to the support 101, just like the example of FIG. 17.

On the other hand, the external end of the substructure 120 is not superposed on the external ends of the internal pages 103a and 104a. In this way, it is, for example, possible to assemble the fibrous layers consisting of the internal pages 103a and 104a together.

FIG. 19 shows an exemplary sectional document 100 according to the invention.

In this example, the sectional document 100 includes two internal leaves 103 and 104.

The internal leaf 103 includes an internal page 103a including a first watermark or pseudo-watermark 110a and an internal page 103b bearing a second watermark or pseudo-watermark 110c. The same applies for the internal leaf 104 which includes an internal page 104a bearing a first watermark or pseudo-watermark 110b and an internal page 104b which bears a second watermark or pseudo-watermark 110d.

The watermarks or pseudo-watermarks 110a to 110d are formed on the internal pages 103a, 103b, 104a and 104b so that the watermarks or pseudo-watermarks 110a and 110b, respectively the watermarks or pseudo-watermarks 110c and 110d, are at least partially superposed.

The sectional document 100 also includes a substructure 120, consisting of an assembly of two distinct substructures or consisting of a single substructure folded at the fold line 102. The substructure 120 is placed between the internal leaves 103 and 104, so as to be at least partially superposed both on the watermarks or pseudo-watermarks 110a and 110b, and on the watermarks or pseudo-watermarks 110c and 110d.

The internal leaf 104 may, for example, be assembled first with the support 101, then the substructure 120 may be assembled in turn with the support 101 at the fold line 102, and finally the internal leaf 103 may be assembled last with the support 101 at the fold line 102.

In this example, the substructure 120 has a width less than the width of the internal leaves 103 and 104 and the width of the support 101 so that the sectional document 100 has areas at the edges of the internal leaves 103 and 104 which make it possible, if necessary, to assemble the fibrous layers formed by the internal pages 103a, 103b, 104a and 104b together.

FIGS. 20 to 23 show other examples of observations of a structure 200 that can be incorporated in a sectional document according to the invention.

In FIGS. 20 and 21, the structure 200 is such that it includes two fibrous layers (not represented) each respectively bearing watermarks 200a and 200b. The structure 200 also includes a substructure (not represented) which is totally superposed on the watermarks 200a and 200b.

FIG. 20 shows the recto side of the structure 200 on which it can be seen that the watermarks 200a borne by the fibrous layer on the recto of the structure 200 are observed only in transmitted light.

FIG. 21 shows the verso side of the structure 200 on which it can be seen that only the watermarks 200b borne by the fibrous layer on the verso side of the structure 200 can be observed in transmitted light.

In FIGS. 22 and 23, the substructure 210, represented by a dark area in the figures, is superposed on only a single part of the watermarks 200a and 200b so that, in the part of the structure 200 without the substructure 210, the watermarks 200a and 200b are superposed on one another by observation in transmitted light.

FIG. 24 shows, in cross section, another exemplary sectional document 100 according to the invention.

The sectional document 100 includes a support 101 defining two sections 101a and 101b linked by a fold line 102.

The sectional document 100 includes one or more internal leaves 103 and 104, which may be as described previously, for example fibrous and/or polymer, and two internal leaves 106 each including a thermoplastic layer only or a thermoplastic layer associated with a thermosealing adhesive layer.

Between the internal leaves 106, a structure 1 according to the invention is placed which includes a substructure 120 and a fibrous layer 2a bearing a watermark or pseudo-watermark 8a. The structure 1 may or may not include one or more adhesive layers to facilitate the assembly with the internal leaves 106.

The structure 1 is assembled, in particular fixed, between the thermoplastic internal leaves 106 when sealing the internal leaves 106 together.

FIGS. 25 and 26 show two examples of binding to form two internal leaves of a sectional document according to the invention.

In the example of FIG. 25, two leaves 103 and 104 are linked by sealing along a strip 105 in order to form two internal leaves for a sectional document according to FIG. 24 of the invention.

In the example of FIG. 26, two leaves 103 and 104 are folded and linked together at a fold line 102 by one of the methods described previously in order to form two internal leaves for a sectional document according to FIG. 24 of the invention.

The internal leaves formed in this way can be linked at the fold line of the cover of a sectional document according to the invention.

FIGS. 27 to 30 show variant embodiments of sectional documents 100 according to the invention.

In FIG. 27, the sectional document is, for example, produced in a way similar to the sectional document 100 described in FIG. 19. However, the substructure 120 extends partially by one of its ends between two parts of the internal leaves 103 and 104 that have no watermark or pseudo-watermark.

FIGS. 28 to 30 illustrate the possibility for the sectional document to have a configuration as described with reference to FIGS. 1a to 1c.

In FIG. 28, the structure is assembled by the end of a part of the fibrous layer 103 with an end of the support 101. After assembly of the fibrous layers bearing the watermarks or pseudo-watermarks 110a and 110b with the substructure 120 to form the structure, the sectional document may have a configuration similar to that of FIG. 1a.

FIGS. 29 and 30 represent, respectively before and after the assembly of the structure, another possibility for producing a sectional document 100 according to the invention.

In this example, the ends of the fibrous layers bearing the watermarks or pseudo-watermarks 110a and 110b are linked to two distinct ends of the support 101, so that the structure is situated between two parts of the support 101. The sectional document then has, once the structure is assembled, a configuration similar to that of FIG. 1a, the central section consisting of the structure.

The invention is not limited to the embodiments described previously. In particular, the substructure can be linked to the support and/or to the fibrous layer or layers of the structure, or, as a variant, be free, that is to say, linked to the support and/or to the fibrous layer or layers of the structure only by the fold area. In the latter case, the substructure is mobile relative to the fibrous layers on an axis of rotation corresponding to the fold line. The authentication of the sectional document can, for example, be done deliberately by holding the substructure and the fibrous layer together in a superposed manner to confirm that the watermark or pseudo-watermark can be observed in light transmitted through the structure, in the translucent region of the substructure, only from the face of the structure situated on the side of the fibrous layer. The substructure can, for example, be inserted between the fibrous layers.

The expression “including a” is synonymous with “including at least one”, unless specified otherwise.

1-17. (canceled)

18. A sectional document comprising:
a support defining at least two sections linked by at least one fold line,
a structure linked to the support and extending at least partially between the two sections when the sectional document is folded, the structure comprising:
a fibrous layer,
a substructure including a translucent region, and
a watermark or pseudo-watermark borne by the fibrous layer and superposed at least partially on the translucent region of the substructure, wherein the watermark or pseudo-watermark is configured to be observed in light transmitted through the structure, in the translucent region of the substructure, and only from the face of the structure situated to the side of the fibrous layer.

19. The document of claim 18, wherein the structure is linked to the support at the fold line.

20. The document of claim 18, wherein the structure is movable relative to the support.

21. The document as claimed in claim 18, wherein the structure comprises an integrated microcircuit device.

22. The document of claim 21, wherein the integrated microcircuit device is in contactless or contact-based communication.

23. The document as claimed in claim 18, wherein the structure comprises two fibrous layers, and the substructure is linked between the fibrous layers, each of the two fibrous layers comprising a watermark or pseudo-watermark configured to be observed in light transmitted through the structure only from the face of the structure situated to the side of the fibrous layer that bears it.

24. The document as claimed in claim 23, wherein said watermarks are partially superposed on the translucent layer, and wherein the watermark of a fibrous layer comprises:
a portion which is combined visually with a portion of the watermark or pseudo-watermark of the other fibrous layer outside of the translucent region of the substructure, and
another portion which is combined visually with no portion of the watermark or pseudo-watermark of the other fibrous layer in the translucent region of the substructure.

25. The document as claimed in claim 23, wherein said watermarks are partially superposed on the translucent layer, and wherein a respective watermark or pseudo-watermark of each fibrous layer is visible at least partially only on the face of the fibrous layer comprising the respective watermark and is visible at least partially on the face of the fibrous layer that does not comprise the respective watermark.

26. The document as claimed in claim 25, wherein said watermarks are partially superposed on the translucent layer, and wherein the respective watermark or pseudo-watermark of each fibrous layer is visible at least partially only on the face of the fibrous layer that comprises the respective watermark in the translucent region of the substructure and is visible at least partially on the face of the fibrous layer that does not include the respective watermark outside the translucent region of the substructure.

27. The document as claimed in claim 18, wherein the substructure is translucent and diffuses light.

28. The document as claimed in claim 18, wherein the substructure comprises at least one polymer layer.

29. The document of claim 28, wherein the polymer layer is chosen from polyethylenes (PE), polyvinylchlorides (PVC), polyethyleneterephthalates (PET), polycarbonates (PC), polyestercarbonates (PEC), polyethyleneterephthalate glycols (PETG), and acrylonitrilebutadiene styrenes (ABS).

30. The document of claim 28, wherein the polymer layer comprises a a film or an extruded layer.

31. The document as claimed in claim 18, wherein the support of the document comprises an integrated microcircuit device and the substructure comprises an electromagnetic disturbance element configured to attenuate, disturb, or block an electromagnetic coupling between the integrated microcircuit device and an external reader of a magnetic material, conductive material or resonator circuit type.

32. The document as claimed in claim 18, wherein the substructure is linked to the support only at the fold line.

33. The document as claimed in claim 18, wherein the document is chosen from an identity document, a passport, a payment means, a requisition or a voucher, a ticket to cultural or sporting events, and a certificate of authenticity.

34. A method for fabricating a sectional document as claimed in claim 18, the method comprising:
forming at least one watermark or pseudo-watermark on a fibrous layer of an internal leaf of the sectional document; and
at least partially superposing a substructure including a translucent region on said at least one watermark or pseudo-watermark borne by said fibrous layer in said translucent region.

35. The method of claim 34, further comprising assembling together the substructure and the fibrous layer.

36. The method of claim 35, wherein the assembling together of the substructure and the fibrous layer comprises permanently assembling together the substructure and the fibrous layer.

37. The method as claimed in claim 36, further comprising folding and linking the internal leaf to the support of the sectional document at the fold line.

38. The method as claimed in claim 37, wherein the internal leaf defines two internal pages on either side of the fold line of the sectional document, each internal page defining a fibrous layer bearing at least one watermark or pseudo-watermark,
wherein folding the internal leaf at the fold line at least partially superposes the watermarks or pseudo-watermarks.

39. The method as claimed in claim 36, wherein the sectional document comprises at least two distinct internal leaves, each internal leaf defining a fibrous layer bearing at least one watermark or pseudo-watermark, the two watermarks or pseudo-watermarks being situated on one and the same side of the fold line so that they are at least partially superposed.

40. The method as claimed in claim 34, wherein the sectional document comprises a first internal leaf and a second internal leaf, each internal leaf defining two internal pages on either side of the fold line and each internal page defining a fibrous layer including at least one watermark or pseudo-watermark, so that the watermarks or pseudo-watermarks of the first and second internal layers situated on one and the same side of the fold line are at least partially superposed.

41. The method as claimed in claim 34, further comprising linking the substructure to the support of the sectional document at the fold line.
